(19) United States
(12) Patent Application Publication
(10) Pub. No.: US 2024/0025495 A1
(43) Pub. Date: Jan. 25, 2024

(54) Shunt Truck-Dock Safety Systems

(71) Applicant: Stabilock, LLC, Loveland, OH (US)

(72) Inventor: Patrick Mark Kimener, Cincinnati, OH (US)

(73) Assignee: Stabilock, LLC, Loveland, OH (US)

(21) Appl. No.: 18/328,208

(22) Filed: Jun. 2, 2023

Related U.S. Application Data
(60) Provisional application No. 63/390,389, filed on Jul. 19, 2022.

(51) Int. Cl. B62D 53/08

(52) U.S. Cl. CPC B62D 53/0842

(57) ABSTRACT

Shunt truck-dock safety systems are disclosed. An example shunt truck-dock safety system may include a shunt truck interlock element configured to selectively prevent and/or allow operation of at least one operable component of a shunt truck and/or a shunt truck controller configured to direct operation of the shunt truck interlock element based at least in part upon a dock condition.

### CROSS REFERENCE TO RELATED APPLICATIONS

This application claims the benefit of U.S. Provisional Patent Application No. 63/390,389, titled “SHUNT TRUCK-DOCK SAFETY SYSTEMS,” filed Jul. 19, 2022, which is incorporated by reference herein in its entirety.

### INTRODUCTION

The present disclosure is directed to safety devices for use with shunt trucks and, more particularly, to safety systems for shunt trucks that may be used, for example, in connection with semi-trailers parked at loading docks, and related methods.

The present disclosure contemplates that distribution warehouses and facilities having semi-trailer loading/unloading capabilities (e.g., facilities with loading/unloading docks) are a necessary component of commerce in the twenty-first century. These warehouses may act as clearinghouses for shipments from various product suppliers and centralize the distribution of goods. Large chain retailers utilize warehouses to generate shipments to particular points of sale that are specific to the needs of consumers in that area, without requiring the original manufacturer of the goods to identify consumer demand at each point of sale and correspondingly deliver the particular goods to each point of sale.

The present disclosure contemplates that an example distribution warehouse (or similar facility) may include fifteen or more loading docks, with each loading dock adapted to receive a single freight trailer of a semi-truck. A loading dock typically includes an opening elevated above ground level (e.g., a mezzanine) to match the height of the floor of the freight trailer. Alternatively, for liquid contents of a semi-trailer, the loading dock may comprise a horizontal or angled floor teamed with piping to allow egress of liquids to and from the semi-trailer. In the context of a warehouse, the relatively equal height between the floor of the loading dock and the floor of the trailer enables lift trucks (e.g., forklifts) and other material handling devices to move freely back and forth between the warehouse and interior of the freight trailer.

The present disclosure contemplates that in an example sequence, a loading dock opening of a facility is initially unoccupied by a freight trailer. Thereafter, a semi-trailer driver or shunt truck driver backs the semi-trailer into alignment with the dock. In the context of a box semi-trailer, this includes backing the rear of the trailer into alignment with the loading dock opening. After the semi-trailer is properly aligned and positioned adjacent to the dock, the driver will either continue the engagement between the truck and trailer, or discontinue the engagement and relocate the truck to a remote location. In the context of shunt trucks, the shunt truck may only be connected to the freight trailer long enough to position it adjacent to the loading dock opening. In an example day, the shunt truck may connect to and disconnect from one hundred or more freight trailers.

The present disclosure contemplates that, in summary fashion, a shunt truck (also known as a spotter truck or yard truck) is a dedicated tractor that stays at the dock facility and is only used to reposition freight trailers (e.g., not to tow the trailers on the open highways). By way of example, a facility may have ten dock openings, but may have fifty trailers waiting to be unloaded and/or unloaded. In order to expedite unloading and loading of contents with respect to the semi-trailer, as well as for the convenience of the semi-truck drivers that deliver to or pick up the trailers from the facility, the trailers may need to be shuffled. This means that trailers do not include dedicated semi-tractors continuously connected to them. Instead, because no semi-tractor is connected to many, if not all, of the trailers at a facility, a shunt truck is necessary to shuffle the trailers at the facility.

The present disclosure contemplates that an exemplary process for engaging between the shunt truck and the freight trailer includes backing the shunt truck under a front end of the semi-trailer so a hydraulic fifth wheel of the shunt truck engages a king pin of the semi-trailer, followed by initially raising the hydraulic fifth wheel to raise the front end of the trailer above its normal ride height. While the front end is raised, the landing gear of the freight trailer, which comprises a pair of equal length jacks permanently mounted to the trailer, are also elevated off the ground to allow repositioning of the trailer. The hydraulic fifth wheel allows the shunt truck to reposition trailers without ever adjusting or otherwise repositioning the trailer's landing gear. As is customary, associated pneumatic and electrical connections between the shunt truck and trailer are connected so that the brakes of the freight trailer are able to be unlocked. Conversely, to disengage the shunt truck from the trailer, the hydraulic fifth wheel may be lowered so that lowering of the fifth wheel is operative to set down the trailer on its landing gear. When the trailer is set down on its landing gear, the trailer is freestanding (e.g., without a mechanical connection between the king pin of the trailer and the fifth wheel of the shunt truck). After the trailer is freestanding, associated pneumatic and electrical connections between the shunt truck and trailer are disconnected so that the brakes of the trailer are locked. Thereafter, the shunt truck pulls out from under the trailer, thereby leaving the trailer adjacent to the dock opening and being supported at the front end using only the trailer's landing gear.

The present disclosure contemplates that a potentially dangerous situation may occur if a semi-trailer is moved away from a dock opening before dock personnel have prepared the semi-trailer and/or the dock for movement of the semi-trailer. Further, the present disclosure contemplates that some loading docks may utilize exterior visual signals, such as red and/or green lights, to indicate whether a semi-trailer is ready for movement. However, such signals typically rely on compliance by shunt truck drivers and/or dock personnel to ensure safety. Accordingly, there is a need in the industry for improved safety devices for shunt trucks for use with semi-trailers parked at loading docks.

It is an aspect of the present disclosure to provide a shunt truck-dock safety system including a shunt truck interlock element configured to selectively prevent and/or allow operation of at least one operable component of a shunt truck and/or a shunt truck controller configured to direct operation of the shunt truck interlock element based at least in part upon a dock condition.

In a detailed embodiment, the at least one operable component of the shunt truck may include a king pin lock of a fifth wheel of the shunt truck and/or the shunt truck interlock element may include a king pin lock interlock configured to selectively prevent and/or allow operation of the king pin lock. The king pin lock interlock may be configured to prevent locking of the king pin lock when an unsafe condition is detected. The king pin lock interlock may be configured to prevent locking of the king pin lock when a safe condition is not detected. The king pin lock interlock may be configured to allow locking of the king pin lock when an unsafe condition is not detected. The king pin lock interlock may be configured to allow locking of the king pin lock when a safe condition is detected. The king pin interlock may include a solenoid valve operatively interposing a compressed air source and the king pin lock.

In a detailed embodiment, the system may include at least one signal receiver operatively coupled to the shunt truck controller. The at least one signal receiver may be configured to receive a signal associated with a dock condition. The at least one signal receiver may include an infrared receiver. The at least one signal receiver may include a plurality of signal receivers.

In a detailed embodiment, the system may include a lateral arm configured to extend laterally from the shunt truck. The at least one signal receiver may be disposed on the arm. The lateral arm may be selectively extendable and retractable. The lateral arm may be pivotably extendable and retractable. The system may include a pneumatic actuator configured to pivotably extend and retract the lateral arm.

In a detailed embodiment, the system may include at least one signal transmitter configured to transmit the signal associated with the dock condition. The signal transmitter may include an infrared emitter. The at least one signal transmitter may include a plurality of signal transmitters. The at least one signal transmitter may be disposed proximate the dock. The signal transmitter may be disposed laterally adjacent a loading dock door of the dock.

In a detailed embodiment, the system may include a dock controller operatively coupled to the signal transmitter. The dock controller may be configured to selectively direct the signal transmitter to transmit the signal associated with the dock condition based at least in part upon the dock condition. The dock controller may be operatively coupled to one or more sensors configured to sense parameters associated with the dock.

In a detailed embodiment, the dock condition may include a dock not ready condition. The dock not ready condition may be associated with one or more of the following: a dock retention device is in an engaged configuration, a dock door is in an open configuration, a dock leveler is in a deployed configuration, an exterior red visible indicium is displayed, and/or an interior green visible indicium is displayed.

In a detailed embodiment, the dock condition may include a dock ready condition. The dock ready condition may be associated with one or more of the following: a dock retention device is in a disengaged configuration, a dock door is in a shut configuration, a dock leveler is in a stored configuration, an exterior green visible indicium is displayed, and/or an interior red visible indicium is displayed.

In a detailed embodiment, operation of the shunt truck controller may differ when a trailer is coupled to the shunt truck and when a trailer is not coupled to the shunt truck. The system may include a trailer detection element operatively coupled to the shunt truck controller. The trailer detection element may be configured to detect the presence of a trailer coupled to the shunt truck.

In a detailed embodiment, the shunt truck controller may include a shunt truck alarm output configured to be coupled to a shunt truck alarm element. The shunt truck alarm element may include a shunt truck aural alarm element configured to generate an audible alarm proximate the shunt truck. The shunt truck aural alarm element may include a horn. The shunt truck alarm element may include a shunt truck visual alarm element configured to generate a visible alarm proximate the shunt truck. The shunt truck visible alarm element may include a light disposed on the shunt truck.

It is an aspect of the present disclosure to provide a method of operating a shunt truck, including directing operation of a shunt truck interlock element based at least in part upon a dock condition. The shunt truck interlock element may be configured to selectively prevent and/or allow operation of at least one operable component of a shunt truck.

In a detailed embodiment, the at least one operable component of the shunt truck may include a king pin lock of a fifth wheel of the shunt truck and/or the shunt truck interlock element may include a king pin interlock configured to selectively prevent and/or allow operation of the king pin lock.

In a detailed embodiment, the method may include, before directing operation of the shunt truck interlock element, receiving a signal associated with the dock condition. Directing operation of the shunt truck interlock element based at least in part upon the dock condition may include directing operation of the shunt truck interlock element based at least in part upon the signal associated with the dock condition.

In a detailed embodiment, the signal associated with the dock condition may include a dock not ready condition. Directing operation of the shunt truck interlock element based at least in part upon the signal associated with the dock condition may include preventing a king pin lock of the shunt truck from locking onto a king pin of a trailer.

In a detailed embodiment, the signal associated with the dock condition may include a dock ready condition. Receiving the signal associated with the dock condition may include receiving an infrared signal transmitted by an emitter mounted proximate a loading dock door. Receiving the signal associated with the dock condition may include receiving the signal associated with the dock condition using an infrared receiver. The method may include, before receiving the signal associated with the dock condition, extending a lateral arm on which the infrared receiver is disposed.

It is an aspect of the present disclosure to provide a method of operating a shunt truck-dock safety system, including transmitting a signal associated with a dock condition to a shunt truck.

In a detailed embodiment, the signal associated with the dock condition may include a dock ready condition. The signal associated with the dock condition may include a dock not ready condition.

In a detailed embodiment, the method may include, before transmitting the signal associated with the dock condition, determining the dock condition. Determining the dock condition may include determining at least one of the following: a dock retention device configuration, a dock door position, and/or a dock leveler configuration. Determining the dock condition may include determining at least one of the following: whether an exterior green visible indicium is displayed, whether an exterior red visible indicium is displayed, whether an interior green visible indicium is displayed, and/or whether an interior red visible indicium is displayed.

It is an aspect of the present disclosure to provide a method of installing shunt-truck-mounted components of a shunt truck-dock safety system, including mounting one or more shunt-truck-mounted components to a shunt truck and/or operatively coupling one or more shunt-truck-mounted components to one or more existing shunt truck systems.

It is an aspect of the present disclosure to provide a method of installing dock-mounted components of a shunt truck-dock safety system, including mounting one or more dock-mounted components to building and/or operatively coupling one or more dock-mounted components to one or more existing dock systems.

It is an aspect of the present disclosure to provide any method, operation, process, system, device, and/or apparatus associated with any of the above aspects or as described herein. It is an aspect of the present disclosure to provide any combination of any one or more elements of any one or more of the above aspects or as described herein.

### BRIEF DESCRIPTION OF THE DRAWINGS

Example embodiments are described in conjunction with the accompanying drawing figures in which:

FIG. 1 is a simplified schematic view of an example shunt truck-dock safety system;

FIG. 2 is a simplified rear elevation view of an example shunt truck;

FIG. 3 is a simplified rear elevation view of a portion of an example stanchion and an example lateral arm;

FIG. 4 is a rear perspective view of alternative example shunt-truck-mounted elements of an example shunt truck-dock safety system in a retracted configuration;

FIG. 5 is a rear perspective view of the shunt-truck-mounted elements of FIG. 4 in an extended configuration;

FIG. 6 is a simplified schematic view of an example shunt truck controller;

FIG. 7 is a simplified schematic view of an example fifth wheel of a shunt truck;

FIG. 8 is a rear elevation view of a shunt truck with the shunt-truck-mounted components of FIGS. 4 and 5 mounted thereon and with the lateral arm in a retracted position;

FIG. 9 is a rear perspective view of the shunt truck with the lateral arm in an intermediate position;

FIG. 10 is a rear elevation view of the shunt truck with the lateral arm in an intermediate position;

FIG. 11 is a rear elevation view of the shunt truck with the lateral arm in the extended position;

FIG. 12 is a rear perspective view of the shunt truck with the lateral arm in the extended position;

FIG. 13 is a perspective view of an exterior of a building including example dock-mounted components of a shunt truck-dock safety system; and

FIG. 14 is a detailed perspective view of an example signal transmitter including an infrared emitter; all in accordance with at least some aspects of the present disclosure.

### DETAILED DESCRIPTION

Example embodiments according to the present disclosure are described and illustrated below to encompass devices, methods, and techniques relating to safety devices for use with shunt trucks, such as safety systems for shunt trucks that may be used, for example, in connection with semi-trailers parked at loading docks. Of course, it will be apparent to those of ordinary skill in the art that the embodiments discussed below are examples and may be reconfigured without departing from the scope and spirit of the present disclosure. It is also to be understood that variations of the example embodiments contemplated by one of ordinary skill in the art shall concurrently comprise part of the instant disclosure. However, for clarity and precision, the example embodiments as discussed below may include optional steps, methods, and features that one of ordinary skill should recognize as not being a requisite to fall within the scope of the present disclosure. Various example embodiments are described and, unless specifically excluded, any element, feature, aspect, or operation described in connection with any example embodiment may be utilized in any combination in connection with any other embodiment.

Some example safety systems for shunt trucks and loading docks according to at least some aspects of the present disclosure may be configured to prevent a shunt truck from pulling a trailer away from a loading dock before the trailer should be pulled. Such “unscheduled departures” may be dangerous because dock personnel and/or equipment may not be ready for the trailer to depart and, thus, may not be in a safe condition. The following description begins with a discussion of various components of exemplary systems, which is followed by a discussion of various exemplary operations involving some exemplary systems.

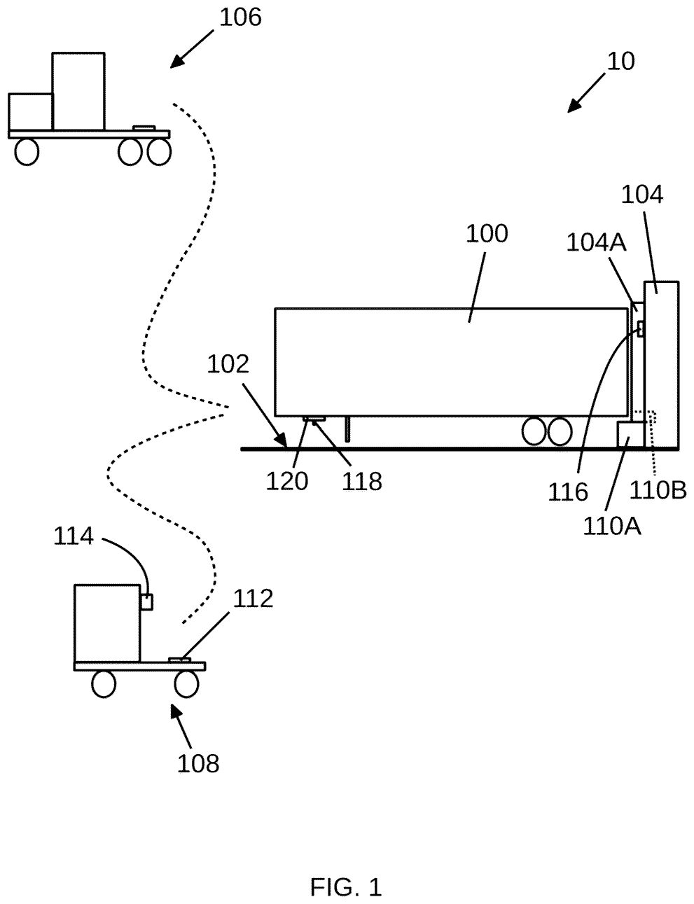

FIG. 1 is a simplified schematic view of an example shunt truck-dock safety system 10, according to at least some aspects of the present disclosure. For context, some example shunt truck-dock systems 10 may include and/or may be used in connection with one or more semi-trailers 100, which may be parked in a parking location 102 proximate a building 104. For example, the building 104 may include a loading dock having one or more loading dock doors 104A. The trailer 100 may be transported relatively long distances by an over-the-road tractor 106 and/or the trailer 100 may be transported relatively short distances by a shunt truck 108, such as by using the shunt truck's fifth wheel 112. When the trailer 100 is parked at the loading dock door 104A, a dock retention device 110A may be engaged to hold the trailer 100 at the loading dock door 104A. The loading dock door 104A may be opened to allow dock personnel to load and/or unload cargo from the interior of the trailer 100. A dock leveler 110B may be utilized to facilitate access to the interior of the trailer 100, such as by a forklift.

Some example shunt truck safety systems 10 according to at least some aspects of the present disclosure may include shunt-truck-mounted components 114 and/or dock-mounted components 116, which may be operatively connected and/or connectable. The shunt-truck-mounted components 114 may be configured to selectively prevent and/or allow operation of at least one operable component of the shunt truck 108. For example, the shunt-truck-mounted elements 114 may be configured to selectively restrict the shunt truck's 108 fifth wheel's 112 ability to lock onto the king pin 118 of the trailer's 100 fifth wheel 120, such as based at least in part upon a dock condition communicated via the dock-mounted components 116.

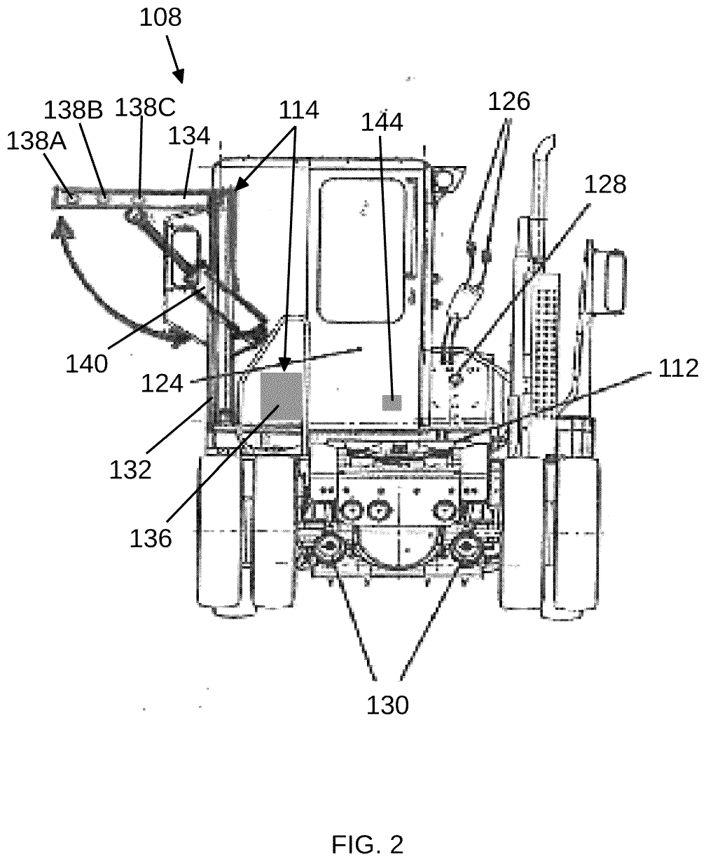

FIG. 2 is a simplified rear elevation view of an example shunt truck 108, according to at least some aspects of the present disclosure. The shunt truck 108 may include the fifth wheel 112, a rear door 124, trailer air brake connectors (e.g., glad hand connectors) 126, a trailer electrical connector 128, and/or air brake chambers 130.

In the illustrated embodiment, example shunt-truck-mounted components 114 of the shunt truck-dock safety system 10 are disposed on the shunt truck 108. In the illustrated embodiment, the shunt-truck-mounted components 114 may include a generally vertical stanchion 132, a lateral arm 134, and/or a shunt truck controller 136.

In the illustrated embodiment, three signal receivers 138A, 138B, 138C are disposed on a rear-facing surface of the lateral arm 134. The signal receivers 138A, 138B, 138C may be configured to receive a signal, such as a signal associated with a dock condition, and/or may be operatively coupled to the shunt truck controller 136.

The lateral arm 134 may be extendable and/or retractable, such as by being pivotable relative to the stanchion 132. In the illustrated embodiment, a pneumatic cylinder 140 is operable to pivotably extend and/or retract the lateral arm 134. In alternative embodiments, the lateral arm 134 may be extended and/or retracted using one or more electromechanical and/or hydraulic actuators, for example. In some example embodiments, the lateral arm 134 may be extended when the shunt truck 108 is put in “reverse” and/or the lateral arm 134 may be retracted when the shunt truck 108 is taken out of “reverse” (e.g., when the shunt truck 108 is put in “drive”).

In some example embodiments, a trailer detection element may be configured to detect the presence of a trailer 100 coupled to the shunt truck 108. For example, a radar unit 144 may be mounted on the shunt truck 108 and may be operatively coupled to the shunt truck controller 136.

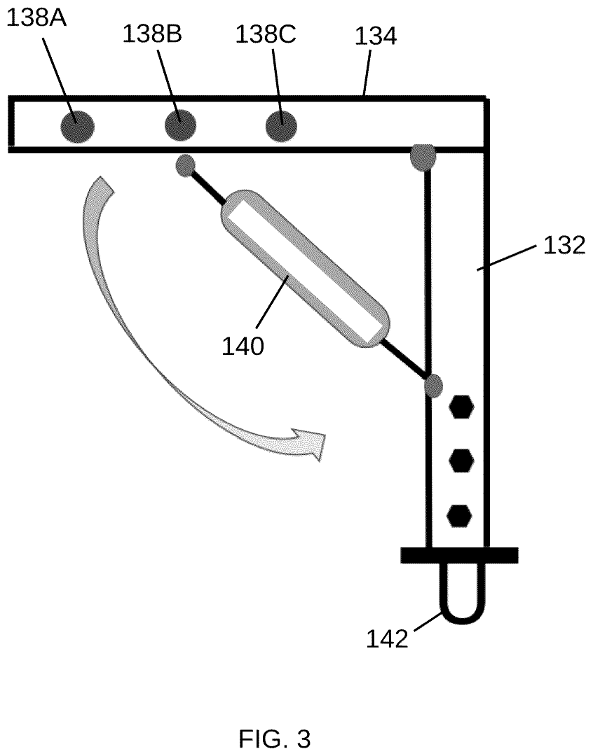

FIG. 3 is a simplified rear elevation view of a portion of an example stanchion 132 and an example lateral arm 134, according to at least some aspects of the present disclosure. In some example embodiments, the vertical stanchion 132 may be length-adjustable to provide height adjustability. In some example embodiments, the vertical stanchion 132 may be configured for attachment to a shunt truck 108 (FIG. 1), such as by a bolt-on U-bracket 142.

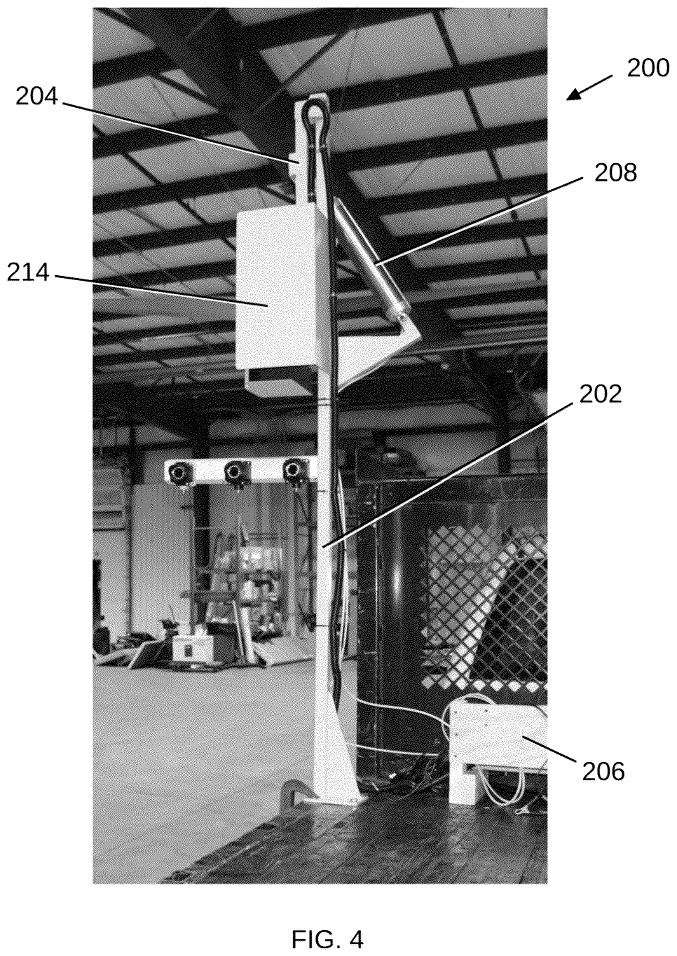

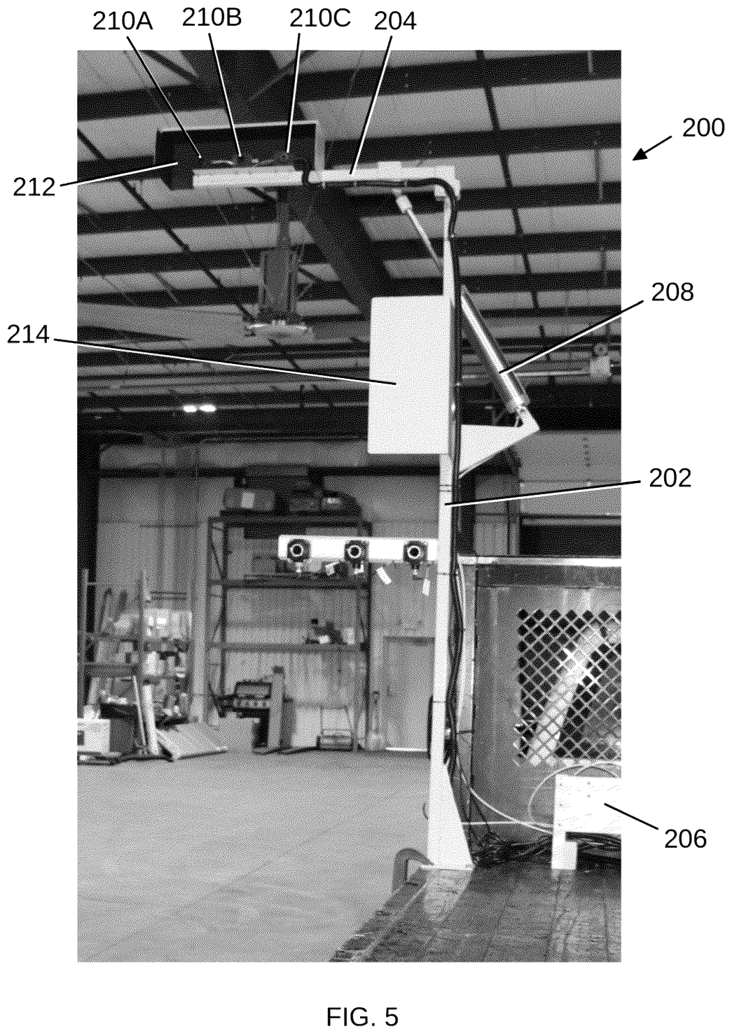

FIG. 4 is a rear perspective view of alternative example shunt-truck-mounted elements 200 of an example shunt truck-dock safety system 10 in a retracted configuration and FIG. 5 is a rear perspective view of the shunt-truck-mounted elements 200 in an extended configuration, all according to at least some aspects of the present disclosure. The shunt-truck-mounted elements 200 are generally similar in construction and operation to those described elsewhere herein, and repeated description of similar features and operations is omitted for brevity. In the illustrated embodiment, the shunt-truck-mounted elements 200 may include a generally vertical stanchion 202, a lateral arm 204, a shunt truck controller 206, and/or a pneumatic actuator 208. Referring to FIG. 5, in the illustrated embodiment, the shunt-truck-mounted elements 200 include three signal receivers 210A, 210B, 210C, which are disposed on a rear surface of the lateral arm 204. In the illustrated embodiment, the signal receivers 210A, 210B, 210C are mounted within a shroud 212, which may be configured to block extraneous incident energy (e.g., infrared light) from reaching the signal receivers 210A, 210B, 210C. Referring to FIGS. 4 and 5, the illustrated embodiment includes a shield 214 disposed on the vertical stanchion 202 that is positioned to at least partially cover the signal receivers 210A, 210B, 210C when the lateral arm 204 is in the retracted configuration. In some alternative example embodiments, a lateral arm 134, 204 may be configured to move between retracted and extended configurations in any manner and/or by utilizing any suitable mechanism, such as by rotating and/or sliding between configurations. In some alternative example embodiments, a lateral arm 134, 204 may be fixed in an extended configuration. In some example embodiments, one or more operable covers may be used to block extraneous incident energy from reaching one or more signal receivers 138A, 138B, 138C, 210A, 210B, 210C.

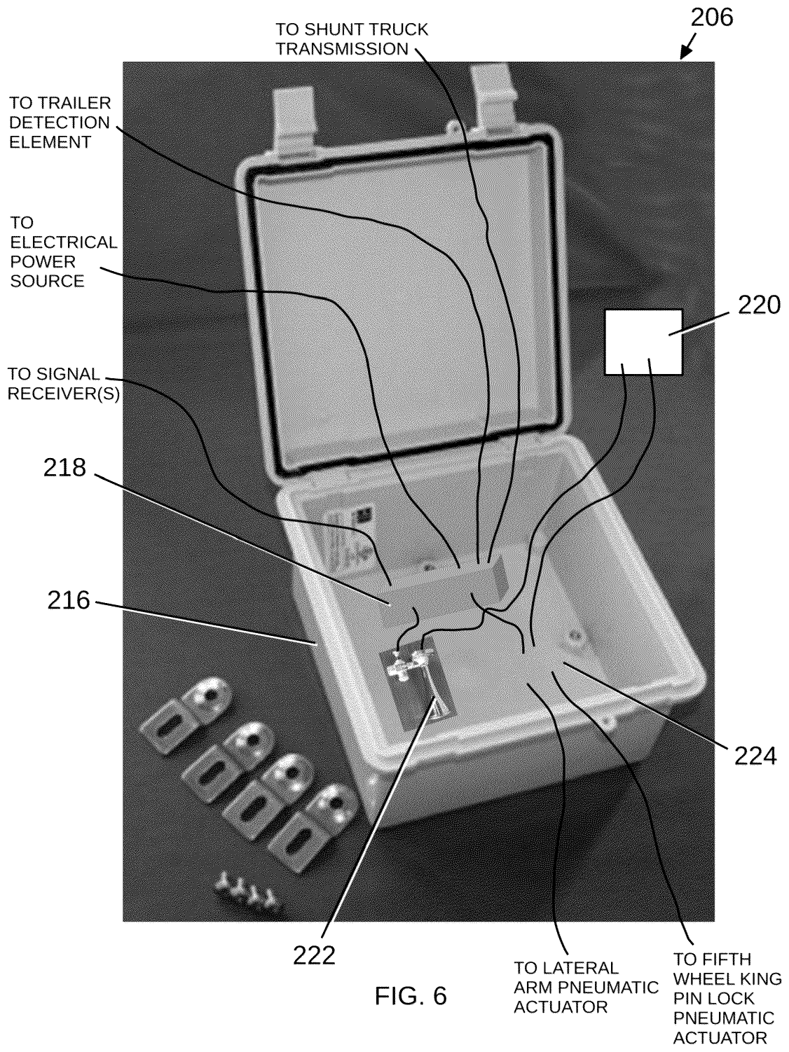

FIG. 6 is a simplified schematic view of an example shunt truck controller 206, according to at least some aspects of the present disclosure. In the illustrated embodiment, the shunt truck controller 206 may include a housing (e.g., weather-resistant box) 216, which may be configured to be mounted on the shunt truck 108. The shunt truck controller 206 may include a shunt truck control unit 218, which may be operatively coupled to various other components. In some example embodiments, the shunt truck control unit 218 may include one or more microprocessors and/or related components. In some example embodiments, the shunt truck control unit 218 may include one or more transistors, relays, and/or similar components. Generally, the shunt truck control unit 218, regardless of its particular construction, may be configured to implement the various logic and/or rules as described herein.

In the illustrated embodiment, the shunt truck control unit 218 may be operatively coupled to the shunt truck 108 transmission (e.g., to determine whether or not the shunt truck is in “reverse”), the trailer detection element (e.g., radar unit 144), an electrical power source (e.g., from the shunt truck 108), one or more signal receivers (e.g., signal receivers 138A, 138B, 138C, 210A, 210B, 210C), a compressed air source 220 (e.g., from the shunt truck 108), a shunt truck alarm element 222, and/or one or more shunt truck interlock elements configured to selectively prevent and/or allow operation of at least one operable component of the shunt truck 108.

In the illustrated embodiment, the shunt truck alarm element 222 may include a shunt truck aural alarm element configured to generate an audible alarm proximate the shunt truck 108. For example, the shunt truck aural alarm element may include an air horn, which may be operatively coupled to the compressed air source 220. In some embodiments, the shunt truck alarm element 222 may include a shunt truck visual alarm element configured to generate a visible alarm proximate the shunt truck, such as a light disposed on the shunt truck.

In the illustrated embodiment, the shunt truck interlock element(s) may include one or more solenoid valves 224, which may operatively interpose the compressed air source 220 and one or more operable components of the shunt truck 108, such as a fifth wheel king pin lock.

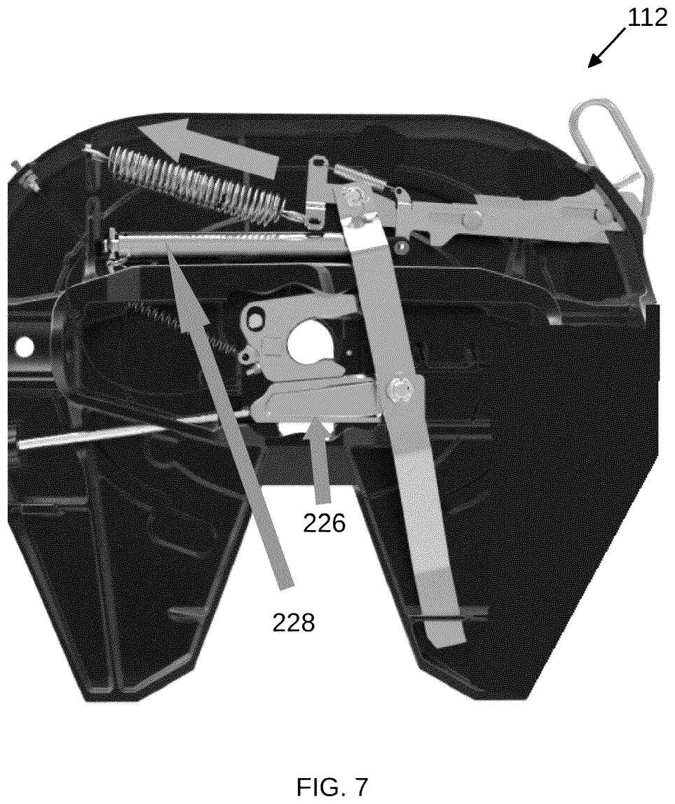

FIG. 7 is a simplified schematic view of an example fifth wheel 112 of a shunt truck 108, accordingly to at least some aspects of the present disclosure. The illustrated fifth wheel 112 is available from JOST International and is configured to couple with the king pin 118 of a trailer 100. The fifth wheel 112 includes a king pin lock 226 configured to lock onto the trailer's 100 king pin 118. Generally, the king pin lock 226 is configured to automatically lock onto the king pin 118 when the shunt truck 108 is coupled to the trailer 100. The king pin lock 226 may be released manually (e.g., by pulling a handle) and/or pneumatically (e.g., by supplying air to a king pin lock pneumatic actuator 228).

In some example embodiments according to at least some aspects of the present disclosure, the shunt truck controller 206 may be operatively coupled to the king pin lock 226. For example, the shunt truck control unit 218 may direct operation of the solenoid valve 224, which may be configured to selectively supply compressed air to the king pin lock pneumatic actuator 228.

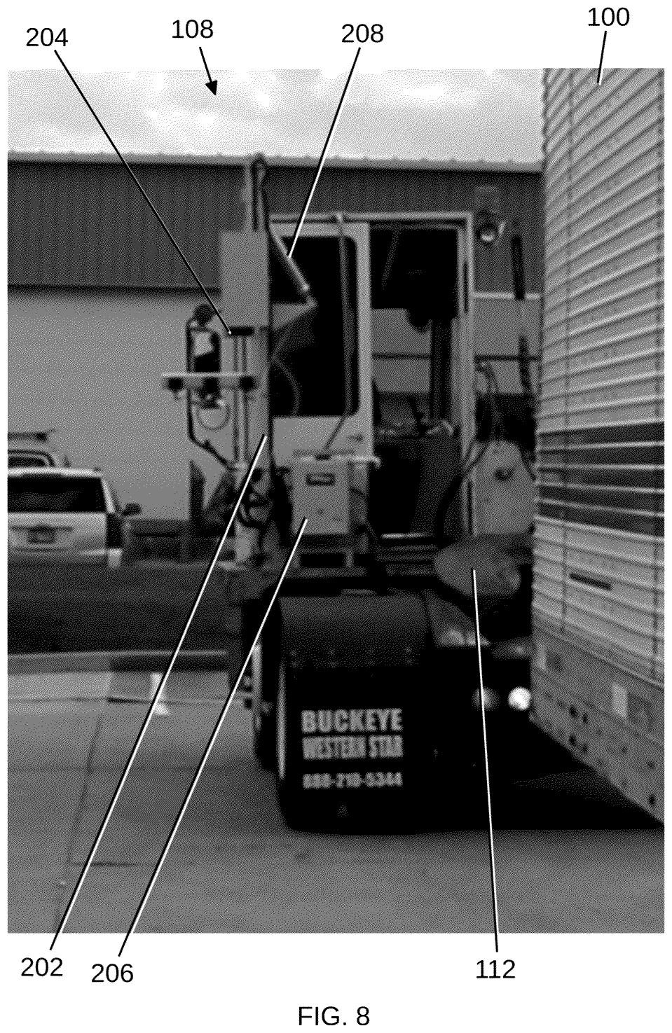

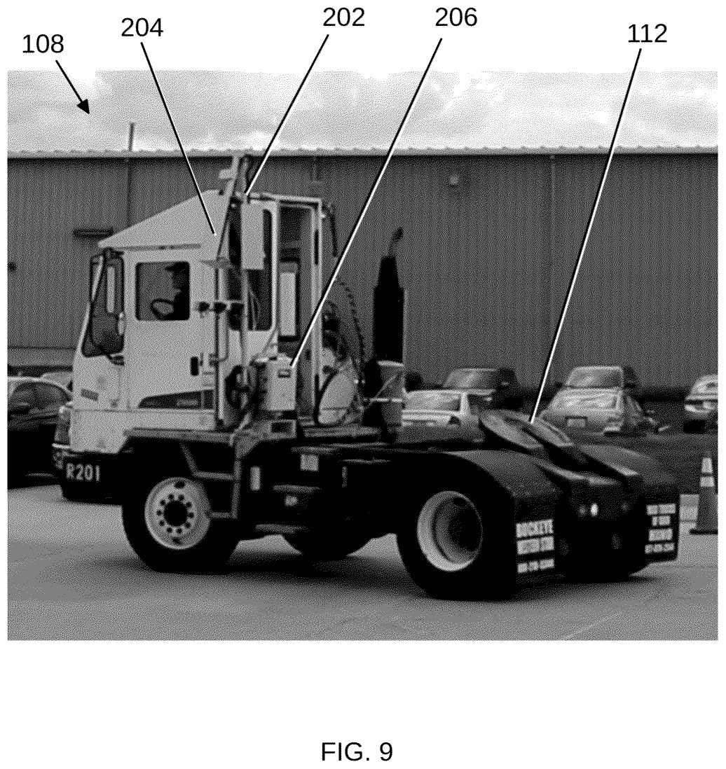

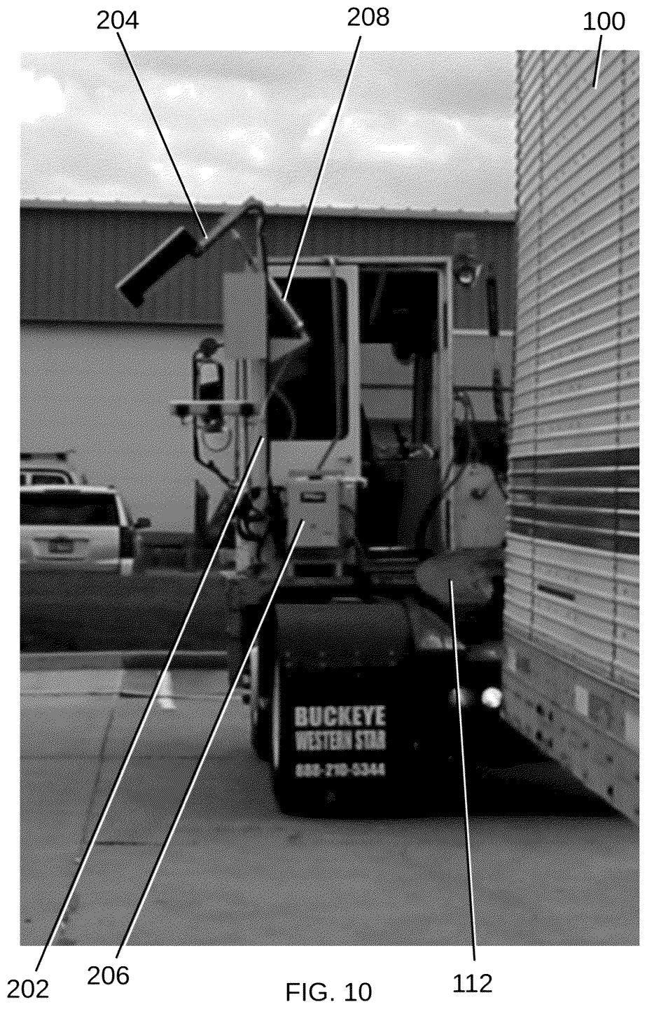

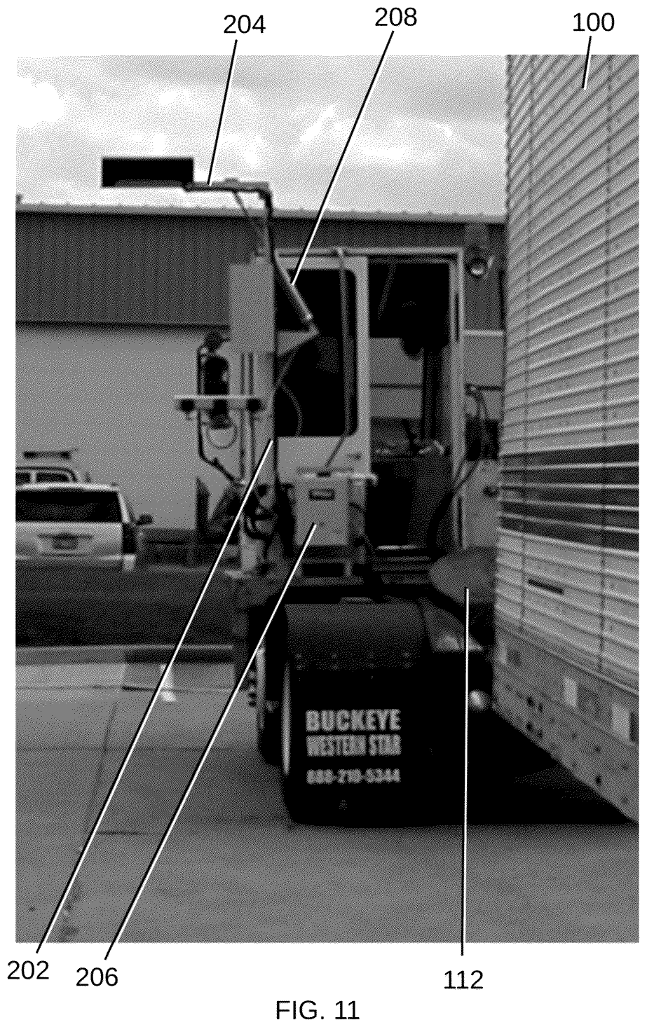

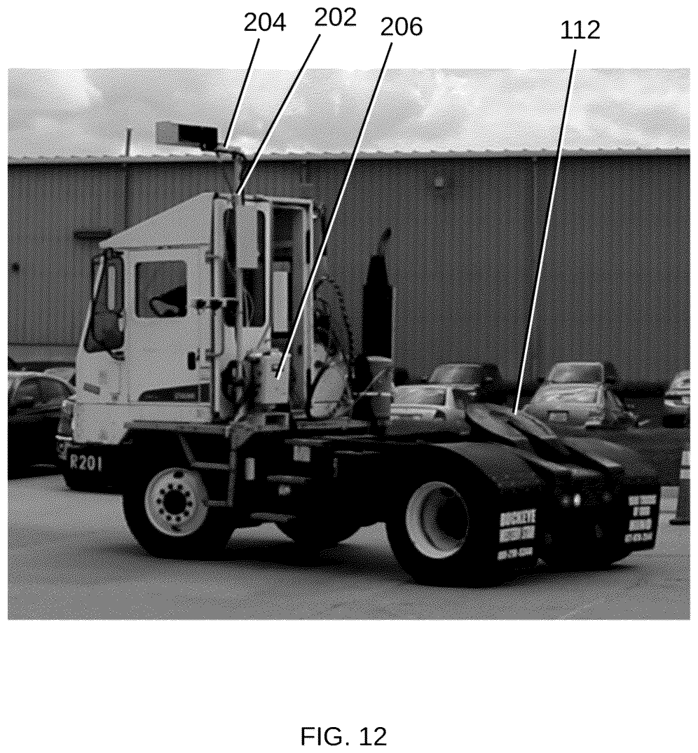

FIG. 8 is a rear elevation view of the shunt truck 108 with the shunt-truck-mounted components 200 of FIGS. 4 and 5 mounted thereon with the lateral arm 204 in a retracted position, FIG. 9 is a rear perspective view of the shunt truck 108 with the lateral arm 204 in an intermediate position, FIG. 10 is a rear elevation view of the shunt truck 108 with the lateral arm 204 in an intermediate position, FIG. 11 is a rear elevation view of the shunt truck 108 with the lateral arm 204 in the extended position, and FIG. 12 is a rear perspective view of the shunt truck with the lateral arm 204 in the extended position, all according to at least some aspects of the present disclosure.

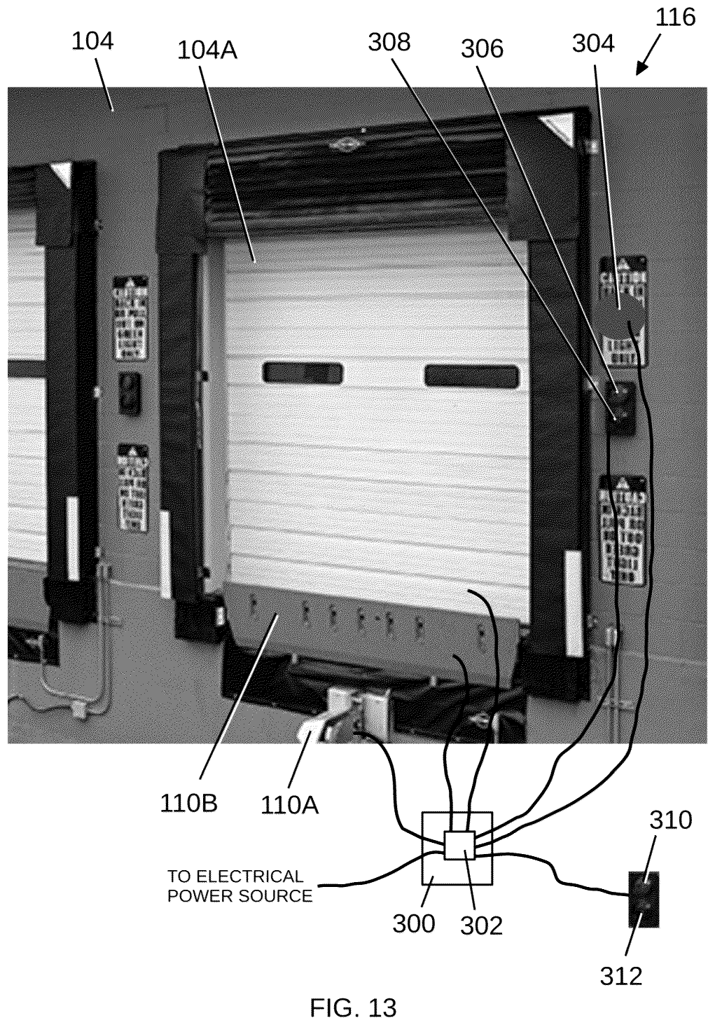

FIG. 13 is a perspective view of an exterior of the building 104 including example dock-mounted components 116 of the shunt truck-dock safety system 10, according to at least some aspects of the present disclosure. The dock-mounted components 116 may include a dock controller 300. The dock controller 300 may include a dock control unit 302, which may be operatively coupled to various other components. In some example embodiments, the dock control unit 302 may include one or more microprocessors and/or related components. In some example embodiments, the dock control unit 302 may include one or more transistors, relays, and/or similar components. Generally, the dock control unit 302, regardless of its particular construction, may be configured to implement the various logic and/or rules as described herein.

In the illustrated embodiment, the dock control unit 302 may be operatively coupled to an electrical power source (e.g., from the building 104), one or more signal transmitters (e.g., an infrared emitter 304), the loading dock door 104A, the retention device 110A, the dock leveler 110B, an exterior visible indicium (e.g., exterior red light 306 and/or exterior green light 308), and/or an interior visible indicium (e.g., interior red light 310 and/or interior green light 312).

For example, the dock control unit 302 may be communicatively coupled to the loading dock door 104A so that a “shut” and/or “not shut” condition of the door can be determined by the dock control unit 302. Similarly, the dock control unit 302 may be communicatively coupled to the retention device 110A so that an “engaged” and/or “disengaged” condition of the retention device 110A can be determined by the dock control unit 302. Likewise, the dock control unit 302 may be communicatively coupled to the dock leveler 110B so that a “deployed” and/or “stored” condition of the dock leveler 110B can be determined by the dock control unit 302.

In some example embodiments, the exterior visible indicium (e.g., exterior red light 306 and/or exterior green light 308) and/or the interior visible indicium (e.g., interior red light 310 and/or interior green light 312) may be configured to illuminate specific lights based upon the condition of the dock door 104A, retention device 110A, and/or dock leveler 110B. For example, the exterior green light 308 may be illuminated when it is safe for a shunt truck driver to spot a trailer 100 to the loading dock door 104A and/or to remove a trailer 100 from the loading dock door 104A. That is, in an example embodiment, the exterior green light 308 may be illuminated when the loading dock door 104A is shut, the retention device 110A is disengaged/stored, and/or the dock leveler 110B is stored. Otherwise, the exterior red light 306 may be illuminated. Similarly, the interior green light 312 may be illuminated when it is safe for dock personnel to access the trailer 100, such as for loading and/or unloading. That is, in an example embodiment, the interior green light 312 may be illuminated when the loading dock door 104A is open, the retention device 110A is engaged, and/or the dock leveler 110B is deployed. Otherwise, the interior red light 310 may be illuminated.

Some example shunt truck-dock safety systems 10 may be communicatively coupled to one or more of the exterior visual indicia and/or interior visual indicia so that the dock control unit 302 can determine which exterior visual indicia and/or interior visual indicia may be displayed (e.g., illuminated). Because the conditions of the dock door 104A, retention device 110A, and/or dock leveler 110B may be utilized in determining which exterior and/or interior indicia are illuminated, the dock control unit's 302 determination of which exterior visual indicia and/or interior visual indicia are illuminated may be utilized instead of and/or in addition to the dock control unit's 302 individual determination of the conditions of the dock door 104A, retention device 110A, and/or dock leveler 110B.

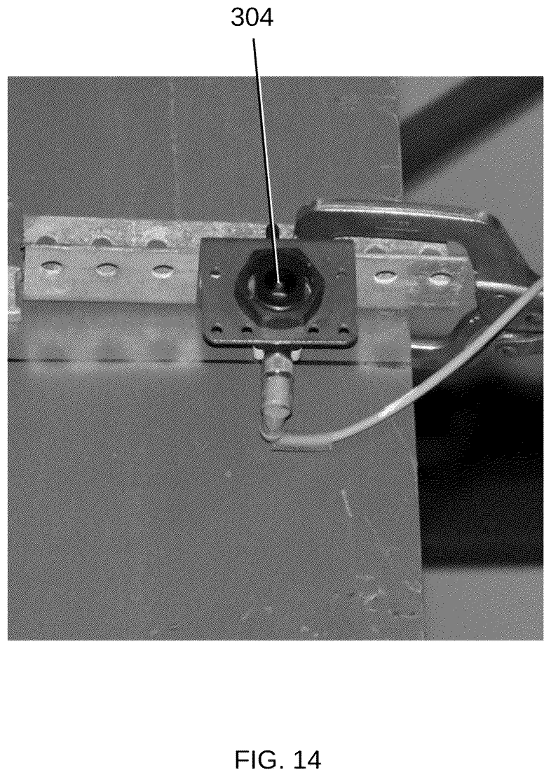

FIG. 14 is a detailed perspective view of an example signal transmitter including the infrared emitter 304, according to at least some aspects of the present disclosure. In the illustrated embodiment, the infrared emitter 304 may include one or more light emitting diodes configured to emit infrared light. In some example embodiments, the infrared emitter 304 may be disposed proximate the dock, such as on an exterior surface of the building 104 laterally adjacent the dock door 104A. In some example embodiments, the infrared emitter 304 may be mounted in an elevated location, such as about 11′ 8″ above the support surface on which the trailer 100 is parked.

Some example embodiments according to at least some aspects of the present disclosure may be configured for continued safety in conditions including failure and/or degraded operation of some elements of a shunt truck-dock safety system. For example, in some embodiments, an infrared emitter 304 may include a primary emitter and a backup emitter. In some embodiments, the backup emitter may be powered from an alternative power source (e.g., batteries). The backup emitter may be configured to be normally inoperative and/or may begin operating if it is determined that the primary emitter is not operational.

In some example embodiments, the dock controller may be operatively coupled to a component associated with a dock, such as to prevent removal of the trailer 100 if the shunt truck-dock safety system is not operable. For example, if it is determined that the infrared emitter 304 may not transmit a signal to the shunt-truck-mounted components 114, such as if the primary emitter and backup emitter are not operable, the dock controller 300 may be configured to prevent disengagement of the retention device 110A.

Example methods involving a shunt truck-dock safety system according to at least some aspects of the present disclosure may include one or more of the following operations. Operations may relate to installation, operation, and/or manufacture of shunt truck-dock safety systems, for example.

Shunt-truck-mounted components 114 as described above may be installed on one or more shunt trucks 108. In some circumstances, such installation operations may involve mounting some components (e.g., the vertical stanchion 132, 202) on the shunt truck 108 and/or operatively coupling the shunt-truck-mounted components 114 with existing shunt truck systems, such as the electrical power source, the compressed air source 220, and/or the at least one operable component of the shunt truck 108 (e.g., king pin lock 226).

Similarly, dock-mounted components 116 as described above may be installed for one or more loading dock doors 104A at a facility. In some circumstances, such installation operations may involve mounting some components (e.g., the emitter 304) on the building 104 and/or operatively coupling the dock-mounted components 116 with existing dock systems, such as the electrical power source, the loading dock door 104A, the retention device 110A, the dock leveler 110B, the exterior visible indicium (e.g., exterior red light 306 and/or exterior green light 308), and/or the interior visible indicium (e.g., interior red light 310 and/or interior green light 312).

Example methods of operation are described beginning with parking a trailer 100 at a loading dock door 104A, such as by an over-the-road tractor 106. Assuming that the loading dock door 104A is shut, the retention device 110A is disengaged, and the dock leveler is stored, the exterior green light 308 may be illuminated. In some example embodiments, the dock-mounted components 114 of the shunt truck-dock safety system 10 may be configured so that the infrared emitter 304 does not emit a signal when these conditions are satisfied and/or when the exterior green light 308 is illuminated.

In this example, because the over-the-road tractor 106 does not include the shunt-truck-mounted components 114 of the shunt truck-dock safety system 10, the over-the-road tractor 106 does not utilize a signal which may or may not be transmitted by the dock-mounted components 116 of the shunt truck-dock safety system 10. The over-the-road tractor 106 driver may rely on the visible exterior indicia, such as the illumination of the exterior green light 308, to determine whether is safe to position the trailer at the loading dock door 104A. Similarly, the interior red light 310 may be illuminated, indicating a status to the dock personnel.

After the over-the-road tractor 106 parks the trailer 100 at the loading dock door 104A, the over-the-road tractor 106 may disconnect from the trailer 100 and/or may drive away. The dock personnel may engage the retention device 110A, may deploy the dock leveler 110B, and/or may open the loading dock door 104A. These operations may cause the exterior red light 306 to illuminate, the exterior green light 308 to extinguish, the interior green light 312 to illuminate, and/or the interior red light 310 to extinguish. Additionally, these operations may cause the dock-mounted components 116 to transmit a signal from the infrared emitter 304.

At this point, if a shunt truck 108 equipped with the shunt-truck-mounted components 114 of the shunt truck-dock safety system 10 attempts to remove the trailer 100 from the loading dock door 104A, the removal will be prevented by the shunt truck-dock safety system 10. Specifically, in an example embodiment, when the shunt truck 108 is put in “reverse,” the lateral arm 134 may be extended. Once the shunt truck 108 is approximately aligned with the trailer 100, the signal receivers 138A, 138B, 138C, 210A, 210B, 210C may be generally aligned to receive a signal from the infrared emitter 304. Because the infrared emitter 304 is emitting a dock condition signal associated with an unsafe condition (e.g., a dock not ready condition), the signal receivers 138A, 138B, 138C, 210A, 210B, 210C may receive the dock condition signal. Upon detection of the dock condition signal associated with the unsafe condition, the shunt truck control unit 218 will direct operation of the shunt truck interlock element to inhibit locking of the king pin lock 226 and/or will actuate the alarm element 222. Upon being alerted by the alarm element 222, the shunt truck 108 driver may discontinue the attempt to couple the shunt truck 108 to the trailer 100. If the shunt truck 108 driver continues to attempt to couple the shunt truck 108 to the trailer 100, the shunt truck fifth wheel 112 may be engaged with the trailer king pin 118. However, because of the operation of the interlock element directed by the shunt truck control unit 218, the king pin lock 226 will be prevented from locking onto the king pin 118 of the trailer 100. Accordingly, if the shunt truck 108 attempts to pull the trailer 100 away from the loading dock door 104A, the king pin 118 will slide out of the shunt truck 108 fifth wheel 112, leaving the trailer 100 parked at the loading dock door 104A. In this manner, this example shunt truck-dock safety system 10 may be operative to prevent an unscheduled removal of a trailer 100 from a loading dock door 104A.

After the dock personnel have completed loading and/or unloading the trailer 100, they may disengage the retention device 110A, may retract the dock leveler 110B, and/or may shut the loading dock door 104A. These operations may cause the exterior red light 306 to extinguish, the exterior green light 308 to illuminate, the interior green light 312 to extinguish, and/or the interior red light 310 to illuminate. Additionally, these operations may cause the dock-mounted components 116 to cease transmitting the signal from the infrared emitter 304.

At this point, if a shunt truck 108 equipped with the shunt-truck-mounted components 114 of the shunt truck-dock safety system 10 attempts to remove the trailer 100 from the loading dock door 104A, the removal will be permitted by the shunt truck-dock safety system 10. Specifically, when the shunt truck 108 is put in “reverse,” the lateral arm 134 may be extended. Once the shunt truck 108 is approximately aligned with the trailer 100, the signal receivers 138A, 138B, 138C, 210A, 210B, 210C may be generally aligned to receive a signal from the infrared emitter 304. Because the infrared emitter 304 is not emitting a dock condition signal associated with an unsafe condition (e.g., a dock not ready condition), the signal receivers 138A, 138B, 138C, 210A, 210B, 210C will not receive the dock condition signal. Accordingly, the shunt truck control unit 218 will direct operation of the shunt truck interlock element to allow locking of the king pin lock 226 and/or will not actuate the alarm element 222. The shunt truck fifth wheel 112 may be engaged with the trailer fifth wheel 120, and the king pin lock 226 will be allowed to lock onto the king pin 118 of the trailer 100. Accordingly, when the shunt truck 108 attempts to pull the trailer 100 away from the loading dock door 104A, the trailer fifth wheel 120 will remain coupled with the shunt truck 108 fifth wheel 112, allowing the shunt truck 108 to pull the trailer 100 away from the loading dock door 104A. In this manner, this example shunt truck-dock safety system 10 may be operative to allow safe removal of a trailer 100 from the loading dock door 104A.

If the shunt truck 108 attempts to couple to a trailer 100 that is not parked at a loading dock door 104A, the shunt-truck-mounted components 114 may operate in substantially the same manner as when the shunt truck 108 attempts to couple to a trailer 100 that is parked at a loading dock 104A that is ready for the trailer 100 to be removed. That is, when the shunt truck 108 is put in “reverse,” the lateral arm 134 may be extended. Once the shunt truck 108 is approximately aligned with the trailer 100, the signal receivers 138A, 138B, 138C, 210A, 210B, 210C may be generally aligned to receive a signal from an infrared emitter 304. Because there is no infrared emitter 304 emitting a dock condition signal associated with an unsafe condition (e.g., a dock not ready condition), the signal receivers 138A, 138B, 138C, 210A, 210B, 210C will not receive the dock condition signal. Accordingly, the shunt truck control unit 218 will direct operation of the shunt truck interlock element to allow locking of the king pin lock 226 and/or will not actuate the alarm element 222. The shunt truck fifth wheel 112 may be engaged with the trailer fifth wheel 120, and the king pin lock 226 will be allowed to lock onto the king pin 118 of the trailer 100. Accordingly, when the shunt truck 108 attempts to pull the trailer 100, the trailer fifth wheel 120 will remain coupled with the shunt truck 108 fifth wheel 112, allowing the shunt truck 108 to pull the trailer 100. In this manner, this example shunt truck-dock safety system 10 may be operative to allow coupling of a shunt truck 108 with a trailer 100 at a location other than a loading dock door 104A with dock-mounted components 116.

In some example embodiments, operation of the shunt truck controller 136, 206 may differ when a trailer 100 is coupled to the shunt truck 108 and when a trailer 100 is not coupled to the shunt truck 108. For example, when the presence of a trailer 100 is detected using the radar unit 144, the shunt truck controller 136, 206 may be configured to allow the king pin lock 226 to remain locked, regardless of whether a signal is detected by the signal receivers 138A, 138B, 138C, 210A, 210B, 210C. Accordingly, detection of an actual or spurious signal by the signal receivers 138A, 138B, 138C, 210A, 210B, 210C may not cause the shunt truck controller 136, 206 to unlock the king pin lock 226.

Example methods of manufacturing apparatus according to at least some aspects of the present disclosure and components thereof may include operations associated with acquiring, producing, and assembling various parts, elements, components, and systems described herein.

Some example embodiments according to at least some aspects of the present disclosure may be utilized in connection with trailer stabilizing devices. In some such embodiments, the presence, status, and/or configuration of a trailer stabilizer may be taken into consideration by a shunt truck-dock safety system, such as in connection with determining whether a safe/unsafe (e.g., dock ready/dock not ready) condition exists.

Unless specifically indicated, it will be understood that the description of any structure, function, and/or methodology with respect to any illustrative embodiment herein may apply to any other illustrative embodiments. More generally, it is within the scope of the present disclosure to utilize any one or more features of any one or more example embodiments described herein in connection with any other one or more features of any other one or more other example embodiments described herein. Accordingly, any combination of any of the features or embodiments described herein is within the scope of this disclosure.

Following from the above descriptions and summaries, it should be apparent to those of ordinary skill in the art that, while the methods and apparatuses herein described constitute example embodiments according to the present disclosure, it is to be understood that the scope of the disclosure contained herein is not limited to the above precise embodiments and that changes may be made without departing from the scope of the disclosure. Likewise, it is to be understood that it is not necessary to meet any or all of the identified advantages or objects disclosed herein in order to fall within the scope of the disclosure, since inherent and/or unforeseen advantages may exist even though they may not have been explicitly discussed herein.

What is claimed is:

1. A shunt truck-dock safety system, the system comprising:
a shunt truck interlock element configured to selectively prevent and/or allow operation of at least one operable component of a shunt truck; and
a shunt truck controller configured to direct operation of the shunt truck interlock element based at least in part upon a dock condition.

2. The system of claim 1,
wherein the at least one operable component of the shunt truck comprises a king pin lock of a fifth wheel of the shunt truck; and
wherein the shunt truck interlock element comprises a king pin lock interlock configured to selectively prevent and/or allow operation of the king pin lock.

3. The system of claim 2, wherein the king pin lock interlock is configured to prevent at least one of locking of the king pin lock when an unsafe condition is detected and locking of the king pin lock when a safe condition is not detected.

4. (canceled)

5. The system of claim 2, wherein the king pin lock interlock is configured to allow at least one of locking of the king pin lock when an unsafe condition is not detected and locking of the king pin lock when a safe condition is detected.

6. (canceled)

7. The system of claim 2, wherein the king pin interlock comprises a solenoid valve operatively interposing a compressed air source and the king pin lock.

8. The system of claim 2,
further comprising at least one signal receiver operatively coupled to the shunt truck controller;
wherein the at least one signal receiver is configured to receive a signal associated with a dock condition.

9.-14. (canceled)

15. The system of claim 8, further comprising at least one signal transmitter configured to transmit the signal associated with the dock condition.

16.-19. (canceled)

20. The system of claim 15,
further comprising a dock controller operatively coupled to the signal transmitter;
wherein the dock controller is configured to selectively direct the signal transmitter to transmit the signal associated with the dock condition based at least in part upon the dock condition.

21. The system of claim 20, wherein the dock controller is operatively coupled to one or more sensors configured to sense parameters associated with the dock.

22. (canceled)

23. The system of claim 20, wherein:
the dock condition comprises a dock not ready condition; and,
the dock not ready condition is associated with one or more of the following:
a dock retention device is in an engaged configuration,
a dock door is in an open configuration,
a dock leveler is in a deployed configuration,
an exterior red visible indicium is displayed, or
an interior green visible indicium is displayed.

24. (canceled)

25. The system of claim 20, wherein:
the dock condition comprises a dock ready condition; and,
the dock ready condition is associated with one or more of the following:
a dock retention device is in a disengaged configuration,
a dock door is in a shut configuration,
a dock leveler is in a stored configuration,
an exterior green visible indicium is displayed, or
an interior red visible indicium is displayed.

26. The system of claim 1, wherein operation of the shunt truck controller differs when a trailer is coupled to the shunt truck and when a trailer is not coupled to the shunt truck.

27. The system of claim 26,
further comprising a trailer detection element operatively coupled to the shunt truck controller;
wherein the trailer detection element is configured to detect the presence of a trailer coupled to the shunt truck.

28. The system of claim 1, wherein the shunt truck controller comprises a shunt truck alarm output configured to be coupled to a shunt truck alarm element.

29. The system of claim 28, wherein the shunt truck alarm element comprises a shunt truck aural alarm element configured to generate an audible alarm proximate the shunt truck.

30. (canceled)

31. The system of claim 28, wherein the shunt truck alarm element comprises a shunt truck visual alarm element configured to generate a visible alarm proximate the shunt truck.

32. The system of claim 31, wherein the shunt truck visible alarm element comprises a light disposed on the shunt truck.

33. A method of operating a shunt truck, the method comprising:
directing operation of a shunt truck interlock element based at least in part upon a dock condition;
wherein the shunt truck interlock element is configured to selectively prevent and/or allow operation of at least one operable component of a shunt truck.

34. The method of claim 33,
wherein the at least one operable component of the shunt truck comprises a king pin lock of a fifth wheel of the shunt truck; and
wherein the shunt truck interlock element comprises a king pin interlock configured to selectively prevent and/or allow operation of the king pin lock.

35. The method of claim 33,
further comprising, before directing operation of the shunt truck interlock element, receiving a signal associated with the dock condition;
wherein directing operation of the shunt truck interlock element based at least in part upon the dock condition comprises directing operation of the shunt truck interlock element based at least in part upon the signal associated with the dock condition.

36.-49. (canceled)
